(19) United States
(12) Patent Application Publication
(10) Pub. No.: US 2025/0302186 A1
(43) Pub. Date: Oct. 2, 2025

(54) LINT AND HAIR REMOVAL TOOL

(71) Applicants: Daniel Crowell, Elkhart, IN (US); Richard D. Hebard, Niles, MI (US)

(72) Inventors: Daniel Crowell, Elkhart, IN (US); Richard D. Hebard, Niles, MI (US)

(21) Appl. No.: 18/904,785

(22) Filed: Oct. 2, 2024

Related U.S. Application Data
(60) Provisional application No. 63/571,405, filed on Mar. 28, 2024.

(51) Int. Cl. A46B 15/00; A01K 13/00; A46B 5/00; A46B 5/02; A46B 7/04; A46B 9/02; A46B 9/06; A46D 1/00; A47L 25/00

(52) U.S. Cl. CPC A46B 15/0055; A46B 5/0008; A46B 5/0075; A46B 5/0095; A46B 5/021; A46B 7/044; A46B 9/02; A46B 9/026; A46B 9/06; A46D 1/0276; A46D 1/0284; A47L 25/005; A01K 13/002; A46B 2200/1093

(57) ABSTRACT

A combination sticky roller and brush, includes a frame, a cylindrical roller, a handle, and at least one groove defined in the frame, parallel to the roller axis of rotation. The at least one groove is to engage and selectably retain a brush head. The frame and the brush head together define a latching mechanism for selectably latching the brush head in a service position and for resisting a predetermined threshold disengaging force. The cylindrical roller has a washable sticky layer defined at a circumferential surface of the cylindrical roller.

### CROSS-REFERENCE TO RELATED APPLICATION

This application claims the benefit of U.S. Provisional Application Ser. No. 63/571,405, filed Mar. 28, 2024, the content of which is incorporated herein by reference in its entirety.

### BACKGROUND

Domesticated animals such as dogs, cats, rabbits, and farm animals such as horses and cows shed fur and hair. This fur and hair can accumulate in undesirable amounts on upholstery, floors and clothing. Lint and dust also can be undesirable on upholstery, floors and clothing. Some domesticated animals enjoy having their hair/fur groomed. Removing loose fur/hair from an animal's coat can reduce the amount of fur/hair that ends up on the floors, upholstery and clothing of the humans associated with the animals. Some fur/hair/lint may cling to garments that are otherwise clean. Some animals may be prepared for shows and competitions by grooming them to present smooth, clean, fur.

### SUMMARY

An aspect provided herein includes a combination sticky roller and brush, comprising: a frame including a first roller support flange attached to a crossmember and a second roller support flange attached to the crossmember spaced apart from the first roller support flange; a first axle pin extending from first roller support flange; a second axle pin extending from the second roller support flange; a cylindrical roller having opposed ends; a bearing disposed on each of the opposed ends to respectively receive the first axle pin and the second axle pin, wherein the first axle pin and the second axle pin selectably retain the cylindrical roller between the first roller support flange and the second roller support flange, and wherein the roller is rotatable about a roller axis of rotation defined by the first axle pin and the second axle pin; a handle, selectably attachable to the frame, the handle having a handle rotational axis of symmetry, the handle having a connecting end, the connecting end complementary with a frame connector defined on the frame; and at least one groove defined in the frame, parallel to the roller axis of rotation, wherein the at least one groove is to engage and selectably retain a brush head, wherein the frame and the brush head together define a latching mechanism for selectably latching the brush head in a service position and for resisting a predetermined threshold disengaging force; wherein the cylindrical roller has a washable sticky layer defined at a circumferential surface of the cylindrical roller.

In examples, the handle rotational axis of symmetry is parallel to the roller axis of rotation. In examples, the handle rotational axis of symmetry is coaxial with the roller axis of rotation when the handle is attached to the frame. In examples, the handle and the frame are configured to attach via a threaded joint.

In examples, the handle rotational axis of symmetry is orthogonal to the roller axis of rotation when the handle is attached to the frame. In examples, the handle rotational axis of symmetry is perpendicular to the roller axis of rotation when the handle is attached to the frame. In examples, the handle and the frame are configured to attach via a threaded joint. In examples, an angle between a line extended normal to a recessed brush head support face and the handle rotational axis of symmetry is about 135 degrees.

In examples, the frame connector includes a threaded socket, and the connecting end of the handle is threaded to be complementary to the threaded socket to facilitate attaching the handle to the frame via a threaded joint.

In examples, the threaded socket is co-molded with the first roller support flange. In examples the threaded socket is co-molded with the crossmember and a gusset supports the threaded socket on the crossmember.

In examples, the bearings include plain bearings defined in hubs defined on each of the opposed ends. In examples, the bearings include bushings inserted into each of the opposed ends.

In examples, the at least one groove includes a T-slot defined in a brush head support face formed on the frame, wherein the T-slot includes a central groove defined parallel to the roller axis of rotation; wherein the brush head includes a T-slot engaging rail to facilitate mounting the brush head on the frame by sliding the T-slot engaging rail into the T-slot.

In examples, the at least one groove includes a pair of opposed, parallel peripheral grooves defined at an edge of a recessed brush head support face formed on the frame, wherein the parallel peripheral grooves are defined parallel to the roller axis of rotation; wherein the brush head includes complementary flanges to engage the parallel peripheral grooves to facilitate mounting the brush head on the frame by sliding the complementary flanges into the parallel peripheral grooves.

In examples, the latching mechanism includes at least one detent defined in the at least one groove defined in the frame, and at least one complementary protrusion to engage the at least one detent and resist removal of the brush head from the service position.

In examples, the brush head has a brush head bed with a planar surface distal to a brush head support face formed in the frame, wherein a plurality of bristles extend from the brush head bed, wherein the bristles are substantially cylindrical having a diameter of about 1/32 inch and a length of about 13/32 inch, wherein the bristles are spaced about 3/32 inch on centers in rows that are spaced 3/32 inch on centers, wherein the brush head has a blade defined along an edge of the brush head bed, wherein the blade projects about 13/16 inch from the edge of the brush head bed, wherein the blade has a trapezoidal cross-section with a base thickness of about ⅛ inch and a minor edge thickness of about 1/16 inch, wherein the blade is void of the bristles.

In examples, the brush head has a brush head bed with a planar surface distal to a brush head support face formed in the frame, wherein a plurality of bristles extend from the brush head bed, wherein the bristles are substantially cylindrical having a diameter of about 1/16 inch and a length of about 13/32 inch, wherein the bristles are spaced about 5/32 inch on centers in rows that are spaced 3/16 inch on centers, wherein the brush head has a blade defined along an edge of the brush head bed, wherein the blade projects about 13/16 inch from the edge of the brush head bed, wherein the blade has a trapezoidal cross-section with a base thickness of about ⅛ inch and a minor edge thickness of about 1/16 inch, wherein the blade is void of the bristles.

In examples: the brush head has a brush head bed with a planar surface distal to a brush head support face formed in the frame, a plurality of bristles extend from the brush head bed, the bristles have a conical surface, each bristle having a bristle axis, a circular base having a base diameter, and a bristle vertex, each axis is normal to the planar surface of the brush head bed, each bristle vertex intersects a respective base center, and the base centers are arranged in a planar rhombic lattice, each base diameter is about 7/32 inch, the bristles are spaced about ¼ inch on centers in rows that are spaced 7/32 inch on centers, the rows include a tall row, the bristles in the tall row have a first height, the rows include a medium row, the bristles in the medium row have a second height, the rows include a short row, the bristles in the short row have third height, the first height is about 13/32 inch, the second height is about 5/16 inch, the third height is about 7/32 inch, the tall rows are each adjacent to a tall row and a respective medium row, and the short rows are each adjacent to a respective medium row.

In examples, the brush head has a brush head bed, wherein the brush head bed includes a surface defining a cylindrical segment, wherein the brush head bed is distal to a brush head support face formed in the frame, wherein a fabric cover is attached to the brush head bed, wherein the fabric cover includes a directional nap, wherein the directional nap is configured to remove fur and hair when brushed in a first direction against a surface having fur or hair thereon, wherein, when brushed in a second direction opposite the first direction, the fur and hair remain on the surface having fur or hair thereon.

In examples, the brush head has a brush head bed with a planar surface distal to a brush head support face formed in the frame, wherein a plurality of bristles, gathered into tufts, extend from the brush head bed, wherein the tufts are attached to the brush head bed in rows in a planar rhombic lattice, wherein the tufts are spaced about 9/16 on centers in rows that are spaced 3/16 on centers, wherein the bristles extend about ¾ inch from the brush head bed.

In examples, the brush head has a brush head bed, wherein the brush head bed includes a surface defining a cylindrical segment, wherein the brush head bed is distal to a brush head support face formed in the frame, wherein a plurality of bristles extend from the brush head bed, wherein the bristles are cylindrical having a diameter of about 1/64 inch and a length of about 17/32 inch, wherein each bristle is normal to the surface defining the cylindrical segment, wherein the bristles are spaced about ¼ inch on centers in rows that are spaced about ⅛ inch on centers at the surface defining the cylindrical segment, wherein each bristle has a ball end affixed to an end of the respective bristle, wherein the ball end has a diameter of about 1/32 inch.

An aspect provided herein includes a modular bimodal brush, comprising: a frame including a crossmember; a handle, selectably attachable to the frame, the handle having a handle rotational axis of symmetry, the handle having a connecting end, the connecting end complementary with a frame connector defined on the frame; at least one first brush head retention groove defined in the frame, parallel to the handle rotational axis of symmetry, wherein the at least one first brush head retention groove is to engage and selectably retain a first brush head, wherein the frame and first brush head together define a first latching mechanism for selectably latching the first brush head in a first service position and for resisting a predetermined threshold disengaging force; at least one second brush head retention groove defined in the frame, parallel to the handle rotational axis of symmetry, wherein the at least one second brush head retention groove is to engage and selectably retain a second brush head, wherein the frame and second brush head together define a second latching mechanism for selectably latching the second brush head in a second service position and for resisting the predetermined threshold disengaging force.

In examples, the at least one first brush head retention groove includes a first pair of opposed, parallel peripheral grooves defined at a first edge of a first recessed brush head support face formed on the frame, wherein the first pair of parallel peripheral grooves is defined parallel to the handle rotational axis of symmetry; wherein the first brush head includes first complementary flanges to engage the first pair of parallel peripheral grooves to facilitate mounting the first brush head on the frame by sliding the first complementary flanges into the first pair of parallel peripheral grooves; wherein the at least one second brush head retention groove includes a second pair of opposed, parallel peripheral grooves defined at a second edge of a second recessed brush head support face formed on the frame, wherein the second pair of parallel peripheral grooves is defined parallel to the handle rotational axis of symmetry; wherein the second brush head includes second complementary flanges to engage the second pair of parallel peripheral grooves to facilitate mounting the second brush head on the frame by sliding the second complementary flanges into the second pair of parallel peripheral grooves, wherein the first brush head is mountable in the second pair of parallel peripheral grooves, and wherein the second brush head is mountable in the first pair of parallel peripheral grooves.

In examples, the first brush head has a first brush head bed with a first planar surface distal to the first recessed brush head support face, wherein a plurality of bristles extend from the first brush head bed, wherein the first bristles are substantially cylindrical having a diameter of about 1/32 inch and a length of about 13/32 inch, wherein the first bristles are spaced about 3/32 inch on centers in rows that are spaced 3/32 inch on centers, wherein the first brush head has a first blade defined along an edge of the first brush head bed, wherein the first blade projects about 13/16 inch from the first edge of the first brush head bed, wherein the first blade has a trapezoidal cross-section with a base thickness of about ⅛ inch and a minor edge thickness of about 1/16 inch, wherein the first blade is void of the first bristles.

In examples, the second brush head has a second brush head bed with a second planar surface distal to the second recessed brush head support face, wherein a plurality of second bristles extend from the second brush head bed, wherein the second bristles are substantially cylindrical having a diameter of about 1/16 inch and a length of about 13/32 inch, wherein the second bristles are spaced about 5/32 inch on centers in rows that are spaced 3/16 inch on centers, wherein the second brush head has a second blade defined along an edge of the second brush head bed, wherein the second blade projects about 13/16 inch from the edge of the second brush head bed, wherein the second blade has a trapezoidal cross-section with a base thickness of about ⅛ inch and a minor edge thickness of about 1/16 inch, wherein the second blade is void of the second bristles.

In examples: the second brush head has a second brush head bed with a second planar surface distal to the second recessed brush head support face, a plurality of second bristles extend from the second brush head bed, the second bristles have a conical surface, each second bristle having an axis, a circular base having a base diameter, and a bristle vertex, each axis is normal to the second planar surface of the second brush head bed, each bristle vertex intersects a respective base center, and the base centers are arranged in a planar rhombic lattice, each base diameter is about 7/32 inch, the second bristles are spaced about ¼ inch on centers in rows that are spaced 7/32 inch on centers, the rows include a tall row, the second bristles in the tall row have a first height, the rows include a medium row the second bristles in the medium row have a second height, the rows include a short row the second bristles in the short row have third height, the first height is about 13/32 inch, the second height is about 5/16 inch, the third height is about 7/32 inch, the tall rows are each adjacent to a tall row and a respective medium row, and the short rows are each adjacent to a respective medium row.

In examples, the second brush head has a second brush head bed, wherein the second brush head bed includes a surface defining a cylindrical segment, wherein the second brush head bed is distal to the second recessed brush head support face, wherein a fabric cover is attached to the second brush head bed, wherein the fabric cover includes a directional nap, wherein the directional nap is configured to remove fur and hair when brushed in a first direction against a surface having fur or hair thereon, wherein, when brushed in a second direction opposite the first direction, the fur and hair remain on the surface having fur or hair thereon.

In examples, the second brush head has a second brush head bed with a second planar surface distal to the second recessed brush head support face, wherein a plurality of second bristles, gathered into tufts, extend from the second brush head bed, wherein the tufts are attached to the second brush head bed in rows in a planar rhombic lattice, wherein the tufts are spaced about 9/16 inch on centers in rows that are spaced 3/16 inch on centers, wherein the second bristles extend about ¾ inch from the second brush head bed.

In examples, the second brush head has a second brush head bed, wherein the second brush head bed includes a surface defining a cylindrical segment, wherein the second brush head bed is distal to the second recessed brush head support face, wherein a plurality of second bristles extends from the second brush head bed, wherein the second bristles are cylindrical having a diameter of about 1/64 inch and a length of about 17/32 inch, wherein each second bristle is normal to the surface defining the cylindrical segment, wherein the second bristles are spaced about ¼ inch on centers in rows that are spaced about ⅛ inch on centers at the surface defining the cylindrical segment, wherein each second bristle has a ball end affixed to an end of the respective second bristle, wherein the ball end has a diameter of about 1/32 inch.

It is to be understood that any combination of features from the aspects and examples disclosed herein may be used together, and/or that any features from any or all of these aspects may be combined with any of the features of the examples disclosed herein to achieve the benefits as described in this disclosure. For example, any of the brush heads may be used as the “first brush head” and combined with any of the brush heads described as the “second brush head” above. It is to be understood that each of these combinations of brush heads is contemplated by the inventors of the present disclosure and disclosed herein by this reference.

An aspect provided herein includes a kit for removing lint and hair from a surface, the kit comprising: at least one first frame, a cylindrical roller, a handle and at least two brush heads selected from the group consisting of: a first brush head, a second brush head, a third brush head, a fourth brush head, a fifth brush head and a sixth brush head; wherein the at least one first frame includes: a first roller support flange attached to a first crossmember and a second roller support flange attached to the first crossmember spaced apart from the first flange; a first axle pin extending from first roller support flange; a second axle pin extending from the second roller support flange; wherein the cylindrical roller includes: opposed ends; a washable sticky layer defined at a circumferential surface of the cylindrical roller; and a bearing disposed on each of the opposed ends to respectively receive the first axle pin and the second axle pin, wherein the first axle pin and the second axle pin selectably retain the cylindrical roller between the first roller support flange and the second roller support flange, and wherein the roller is rotatable about a roller axis of rotation defined by the first axle pin and the second axle pin; wherein the handle is selectably attachable to the at least one first frame, the handle having a handle rotational axis of symmetry, the handle having a connecting end, the connecting end complementary with a frame connector defined on the at least one first frame; wherein at least one groove is defined in the at least one first frame, parallel to the roller axis of rotation, wherein the at least one groove is to engage and selectably retain a first of the at least two brush heads, wherein the at least one first frame and the first of the at least two brush heads together define a first latching mechanism for selectably latching the first of the at least two brush heads in a first service position and for resisting a predetermined threshold disengaging force; wherein the first brush head has a first brush head bed with a first planar surface distal to a brush head support face formed in the at least one first frame, wherein a first plurality of first bristles extend from the first brush head bed, wherein the first bristles are substantially cylindrical having a diameter of about 1/32 inch and a length of about 13/32, wherein the first bristles are spaced about 3/32 inch on centers in rows that are spaced 3/32 inch on centers, wherein the first brush head has a first blade defined along an edge of the first brush head bed, wherein the first blade projects about 13/16 inch from the edge of the first brush head bed, wherein the first blade has a trapezoidal cross-section with a first base thickness of about ⅛ inch and a first minor edge thickness of about 1/16 inch, wherein the first blade is void of the first bristles; wherein the second brush head has a second brush head bed with a second planar surface distal to a brush head support face formed in the at least one first frame, wherein a second plurality of second bristles extend from the second brush head bed, wherein the second bristles are substantially cylindrical having a second bristle diameter of about 1/16 inch and a second bristle length of about 13/32 inch, wherein the second bristles are spaced about 5/32 inch on centers in rows that are spaced 3/16 inch on centers, wherein the second brush head has a second blade defined along an edge of the second brush head bed, wherein the second blade projects about 13/16 inch from the edge of the second brush head bed, wherein the second blade has a trapezoidal cross-section with a base thickness of about ⅛ inch and a minor edge thickness of about 1/16 inch, wherein the second blade is void of the second bristles. wherein: the third brush head has a third brush head bed with a third planar surface distal to a brush head support face formed in the at least one first frame; a plurality of third bristles extend from the third brush head bed; the third bristles have a conical surface, each third bristle having an axis, a circular base having a third base diameter, and a third bristle vertex; each third bristle axis is normal to the third planar surface of the third brush head bed; each third bristle vertex intersects a respective base center, and the base centers are arranged in a planar rhombic lattice; each base diameter is about 7/32 inch; the third bristles are spaced about ¼ inch on centers in rows that are spaced 7/32 inch on centers; the rows include a tall row; the third bristles in the tall row have a first height; the rows include a medium row; the third bristles in the medium row have a second height; the rows include a short row; the third bristles in the short row have third height; the first height is about 13/32 inch; the second height is about 5/16 inch; the third height is about 7/32 inch; the tall rows are each adjacent to a tall row and a respective medium row; and the short rows are each adjacent to a respective medium row; wherein the fourth brush head has a fourth brush head bed, wherein the fourth brush head bed includes a fourth surface defining a fourth cylindrical segment, wherein the fourth brush head bed is distal to a brush head support face formed in the at least one first frame, wherein a fabric cover is attached to the fourth brush head bed, wherein the fabric cover includes a directional nap, wherein the directional nap is configured to remove fur and hair when brushed in a first direction against a surface having fur or hair thereon, wherein, when brushed in a second direction opposite the first direction, the fur and hair remain on the surface having fur or hair thereon; wherein the fifth brush head has a fifth brush head bed with a fifth planar surface distal to a brush head support face formed in the at least one first frame, wherein a plurality of fifth bristles, gathered into tufts, extend from the fifth brush head bed, wherein the tufts are attached to the fifth brush head bed in rows in a planar rhombic lattice, wherein the tufts are spaced about 9/16 inch on centers in rows that are spaced 3/16 inch on centers, wherein the fifth bristles extend about ¾ inch from the fifth brush head bed, wherein the sixth brush head has a sixth brush head bed, wherein the sixth brush head bed includes a sixth surface defining a sixth cylindrical segment, wherein the sixth brush head bed is distal to a brush head support face formed in the at least one first frame, wherein a plurality of sixth bristles extend from the sixth brush head bed, wherein the sixth bristles are cylindrical having a diameter of about 1/64 inch and a length of about 17/32 inch, wherein each sixth bristle is normal to the sixth surface defining the sixth cylindrical segment, wherein the sixth bristles are spaced about ¼ inch on centers in rows that are spaced about ⅛ inch on centers at the sixth surface defining the sixth cylindrical segment, wherein each sixth bristle has a ball end affixed to an end of the respective sixth bristle, wherein the ball end has a diameter of about 1/32 inch.

In examples, the kit further comprises: a second frame including a second crossmember, wherein the handle is selectably attachable to the second frame, wherein the connecting end of the handle is complementary with a second frame connector defined on the second frame; at least one first brush head retention groove defined in the second frame, parallel to the handle rotational axis of symmetry, wherein the at least one first brush head retention groove is to engage and selectably retain the first of the at least two brush heads, wherein the second frame and the first of the at least two brush heads together define a second latching mechanism for selectably latching the first of the at least two brush heads in a second service position and for resisting a predetermined threshold disengaging force; and at least one second brush head retention groove defined in the second frame, parallel to the handle rotational axis of symmetry, wherein the at least one second brush head retention groove is to engage and selectably retain a second of the at least two brush heads, wherein the second frame and the second of the at least two brush heads together define a third latching mechanism for selectably latching the second of the at least two brush heads in a third service position and for resisting the predetermined threshold disengaging force, wherein two of the at least two brush heads are simultaneously respectively mountable in the second service position and the third service position.

In examples, the at least one first brush head retention groove includes a first pair of opposed, parallel peripheral grooves defined at a first edge of a first recessed brush head support face formed on the second frame, wherein the first pair of parallel peripheral grooves is defined parallel to the handle rotational axis of symmetry; wherein the first of the at least two brush heads includes first complementary flanges to engage the first pair of parallel peripheral grooves to facilitate mounting the first of the at least two brush heads on the second frame by sliding the first complementary flanges into the first pair of parallel peripheral grooves; wherein the at least one second brush head retention groove includes a second pair of opposed, parallel peripheral grooves defined at a second edge of a second recessed brush head support face formed on the second frame, wherein the second pair of parallel peripheral grooves is defined parallel to the handle rotational axis of symmetry; wherein the second of the at least two brush heads includes second complementary flanges to engage the second pair of parallel peripheral grooves to facilitate mounting the second of the at least two brush heads on the second frame by sliding the second complementary flanges into the second pair of parallel peripheral grooves, wherein the first of the at least two brush heads is mountable in the first pair of parallel peripheral grooves, and wherein the second of the at least two brush heads is mountable in the second pair of parallel peripheral grooves.

In examples, the at least one first frame includes: a parallel frame, wherein the handle rotational axis of symmetry is parallel to the roller axis of rotation of the parallel frame; and an orthogonal frame, wherein the handle rotational axis of symmetry is orthogonal to the roller axis of rotation of the orthogonal frame.

It is to be understood that any combination of features from the aspects and examples disclosed herein may be used together, and/or that any features from any or all of these aspects may be combined with any of the features of the examples disclosed herein to achieve the benefits as described in this disclosure. For example, any of the brush heads may be used as the “first brush head” and combined with any of the brush heads described as the “second brush head” above. It is to be understood that each of these combinations of brush heads is contemplated by the inventors of the present disclosure and disclosed herein by this reference. Further, the kit may have any combination and or quantity of the frames disclosed herein.

### BRIEF DESCRIPTION OF THE DRAWINGS

Features of examples of the present disclosure will become apparent by reference to the following detailed description and drawings, in which like reference numerals correspond to similar, though perhaps not identical components. For the sake of brevity, reference numerals or features having a previously described function may or may not be described in connection with other drawings in which they appear.

FIG. 1 is a perspective view of an example of a combination sticky roller and brush as disclosed herein;

FIG. 2 is a perspective exploded view of the example depicted in FIG. 1;

FIG. 3 is a perspective view of an example of a modular bimodal brush as disclosed herein;

FIG. 4 is a perspective exploded view of the example depicted in FIG. 3;

FIG. 5 is a perspective view of another example of a combination sticky roller and brush as disclosed herein;

FIG. 6 is a perspective exploded view of the example depicted in FIG. 5;

FIG. 7A is a front detail view of an example of a handle as disclosed herein, with a direction of the view shown in FIG. 2, FIG. 4, and FIG. 6;

FIG. 7B is a side detail view of the example of the handle as depicted in FIG. 7A, with a direction of the view shown in FIG. 2, FIG. 4, and FIG. 6;

FIG. 8A is a left side detail view of an example of a frame as disclosed herein, with a direction of the view shown in FIG. 2;

FIG. 8B is a front detail view of the example of the frame depicted in FIG. 8A, with a direction of the view shown in FIG. 2

FIG. 8C is a right side detail view of the example of the frame depicted in FIG. 8A, with a direction of the view shown in FIG. 2;

FIG. 8D is a partial bottom detail view of the example of the frame depicted in FIG. 8A, with a direction of the view shown in FIG. 2;

FIG. 8E is a partial top detail view of the example of the frame depicted in FIG. 8A, with a direction of the view shown in FIG. 2;

FIG. 9A is a side detail view of another example of the frame as disclosed herein, with a direction of the view shown in FIG. 4, the left side and right side details are identical as shown by the direction arrows in FIG. 4;

FIG. 9B is a front detail view of the example of the frame depicted in FIG. 9A, with a direction of the view shown in FIG. 4

FIG. 9C is a bottom detail view of the example of the frame depicted in FIG. 9A, with a direction of the view shown in FIG. 4;

FIG. 9D is a top detail view of the example of the frame depicted in FIG. 9A, with a direction of the view shown in FIG. 4;

FIG. 10A is a front detail view of yet another example of a frame as disclosed herein, with a direction of the view shown in FIG. 6;

FIG. 10B is a right side detail view of the example of the frame depicted in FIG. 10A, with a direction of the view shown in FIG. 6;

FIG. 10C is a bottom detail view of the example of the frame depicted in FIG. 10A, with a direction of the view shown in FIG. 6;

FIG. 10D is an oblique detail view of the example of the frame depicted in FIG. 10A, with a direction of the view shown in FIG. 6;

FIG. 11A is a top detail view of an example of a cylindrical roller as disclosed herein, with a direction of the view shown in FIG. 2 and FIG. 6;

FIG. 11B is a front detail view of an example of a cylindrical roller as disclosed herein, with a direction of the view shown in FIG. 2 and FIG. 6;

FIG. 12A is a perspective view of an example of a brush head as disclosed herein;

FIG. 12B is a perspective view of another example of a brush head as disclosed herein;

FIG. 12C is a perspective view of yet another example of a brush head as disclosed herein;

FIG. 12D is a perspective view of still another example of a brush head as disclosed herein;

FIG. 12E is a perspective view of a further example of a brush head as disclosed herein;

FIG. 12F is a perspective view of another further example of a brush head as disclosed herein;

FIG. 13A is a top detail view of the example of the brush head depicted in FIG. 12A, with a direction of the view shown in FIG. 2, FIG. 4 and FIG. 6;

FIG. 13B is a front detail view (rotated 90 degrees to save space in the drawings) of the example of the brush head depicted in FIG. 12A, with a direction of the view shown in FIG. 2, FIG. 4 and FIG. 6;

FIG. 13C is a right side detail view (rotated 90 degrees to save space in the drawings) of the example of the brush head depicted in FIG. 12A, with a direction of the view shown in FIG. 2, FIG. 4 and FIG. 6;

FIG. 14A is a top detail view of the example of the brush head depicted in FIG. FIG. 12B, with a direction of the view shown in FIG. 2, FIG. 4 and FIG. 6;

FIG. 14B is a front detail view (rotated 90 degrees to save space in the drawings) of the example of the brush head depicted in FIG. 12B, with a direction of the view shown in FIG. 2, FIG. 4 and FIG. 6;

FIG. 14C is a right side detail view (rotated 90 degrees to save space in the drawings) of the example of the brush head depicted in FIG. 12B, with a direction of the view shown in FIG. 2, FIG. 4 and FIG. 6;

FIG. 15A is a top detail view of the example of the brush head depicted in FIG. 12C, with a direction of the view shown in FIG. 2, FIG. 4 and FIG. 6;

FIG. 15B is a front detail view (rotated 90 degrees to save space in the drawings) of the example of the brush head depicted in FIG. 12C, with a direction of the view shown in FIG. 2, FIG. 4 and FIG. 6;

FIG. 15C is a right side detail view (rotated 90 degrees to save space in the drawings) of the example of the brush head depicted in FIG. 12C, with a direction of the view shown in FIG. 2, FIG. 4 and FIG. 6;

FIG. 16A is a top detail view of the example of the brush head depicted in FIG. 12D, with a direction of the view shown in FIG. 2, FIG. 4 and FIG. 6;

FIG. 16B is a front detail view (rotated 90 degrees to save space in the drawings) of the example of the brush head depicted in FIG. 12D, with a direction of the view shown in FIG. 2, FIG. 4 and FIG. 6;

FIG. 16C is a right side detail view (rotated 90 degrees to save space in the drawings) of the example of the brush head depicted in FIG. 12D, with a direction of the view shown in FIG. 2, FIG. 4 and FIG. 6;

FIG. 17A is a top detail view of the example of the brush head depicted in FIG. 12E, with a direction of the view shown in FIG. 2, FIG. 4 and FIG. 6;

FIG. 17B is a front detail view (rotated 90 degrees to save space in the drawings) of the example of the brush head depicted in FIG. 12E, with a direction of the view shown in FIG. 2, FIG. 4 and FIG. 6;

FIG. 17C is a right side detail view (rotated 90 degrees to save space in the drawings) of the example of the brush head depicted in FIG. 12E, with a direction of the view shown in FIG. 2, FIG. 4 and FIG. 6;

FIG. 18A is a top detail view of the example of the brush head depicted in FIG. 12F, with a direction of the view shown in FIG. 2, FIG. 4 and FIG. 6;

FIG. 18B is a front detail view (rotated 90 degrees to save space in the drawings) of the example of the brush head depicted in FIG. 12F, with a direction of the view shown in FIG. 2, FIG. 4 and FIG. 6; and

FIG. 18C is a right side detail view (rotated 90 degrees to save space in the drawings) of the example of the brush head depicted in FIG. 12F, with a direction of the view shown in FIG. 2, FIG. 4 and FIG. 6.

### DETAILED DESCRIPTION

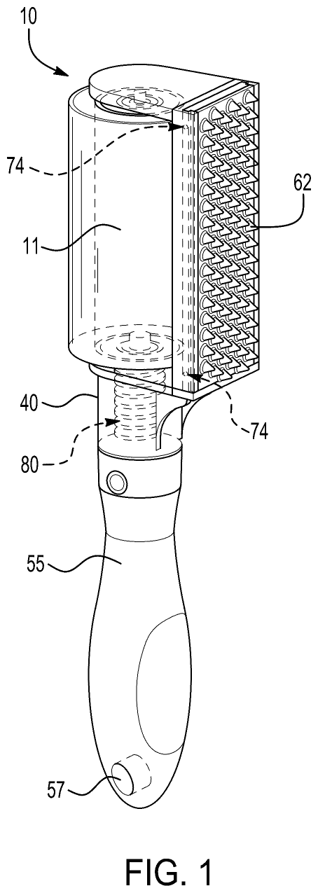

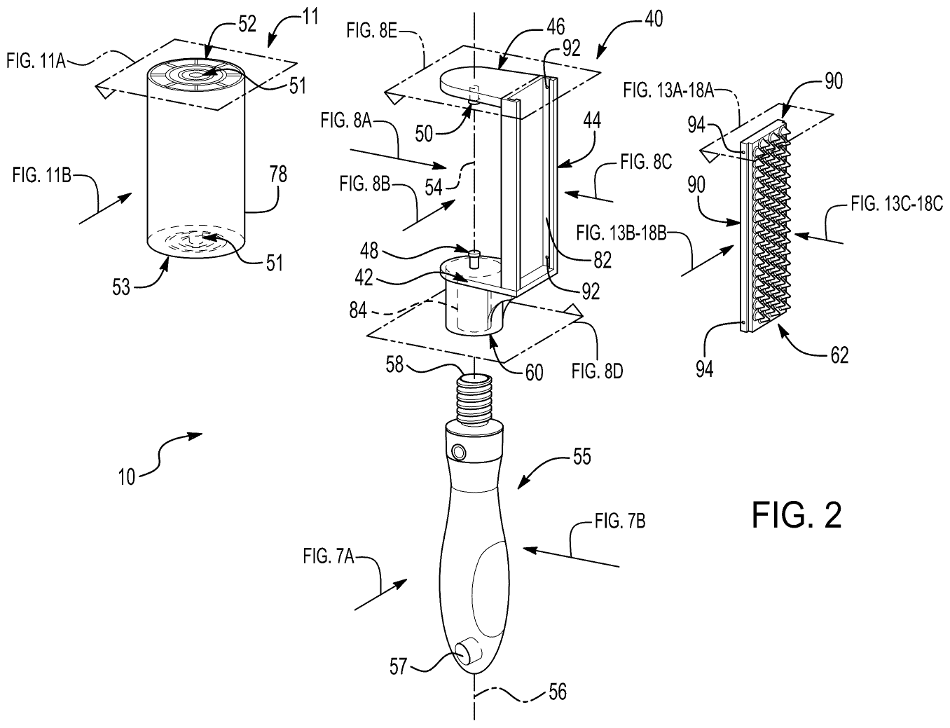

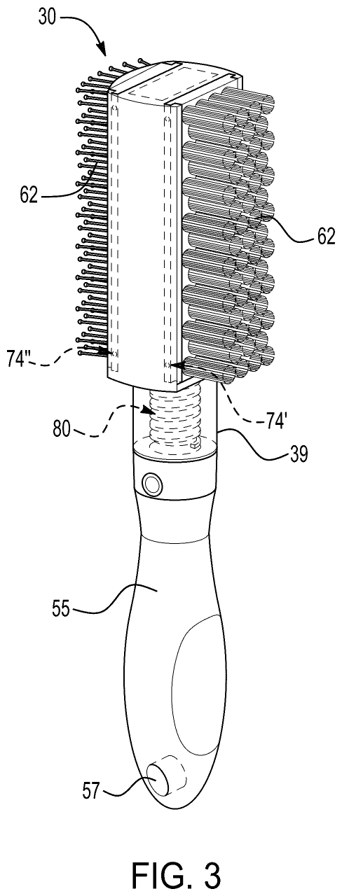

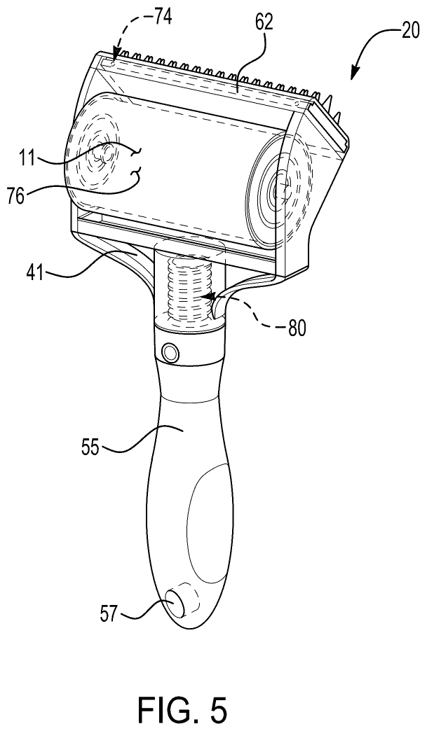

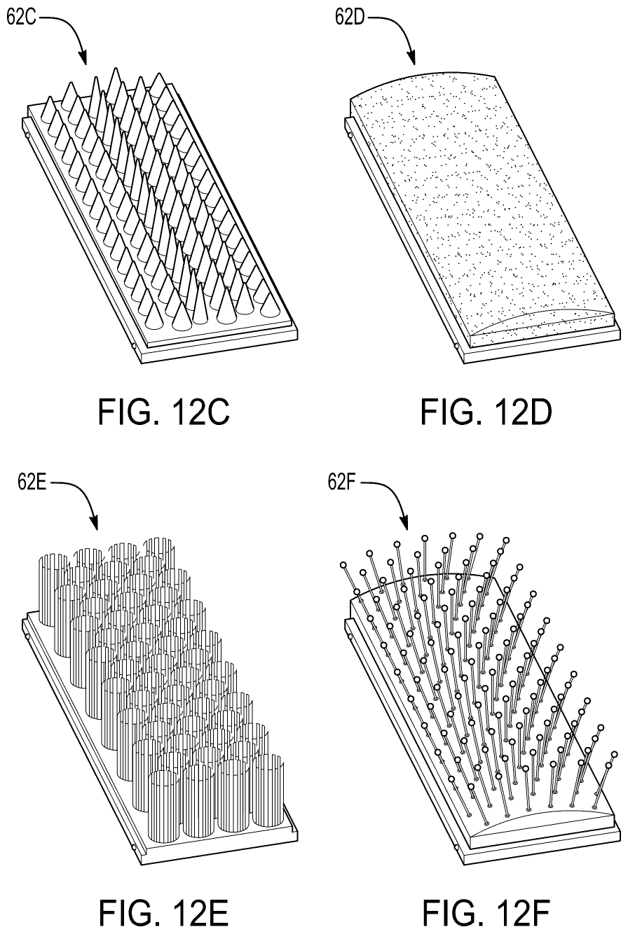

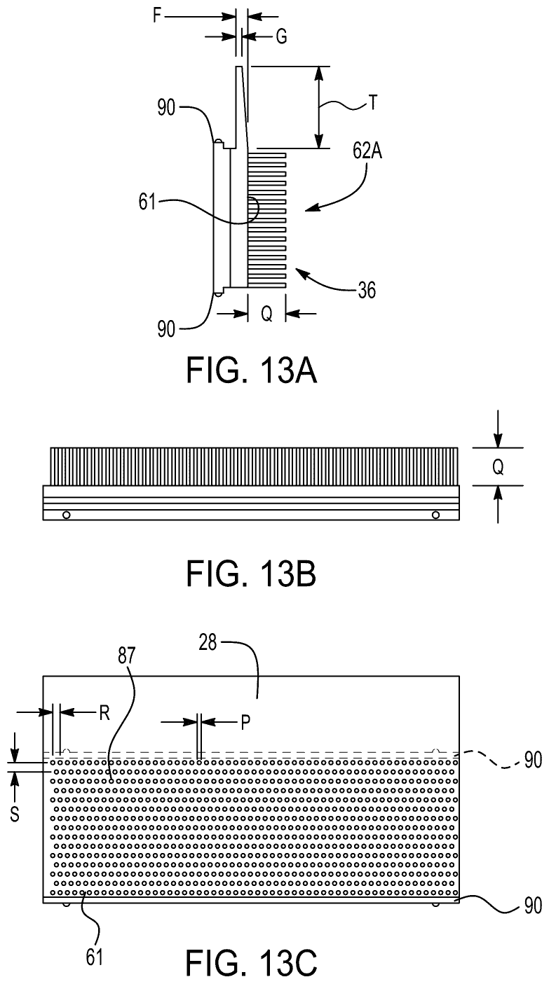

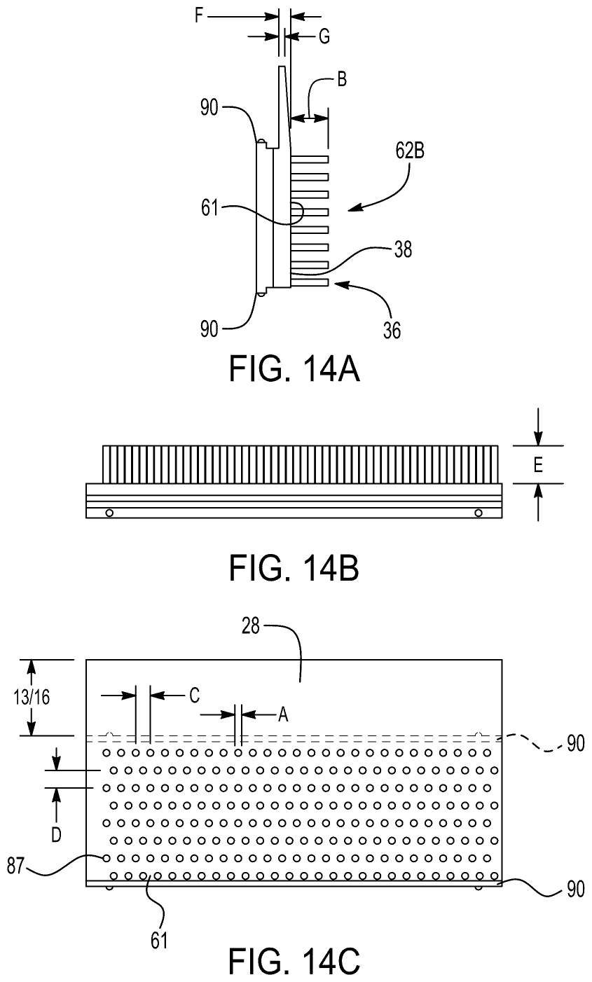

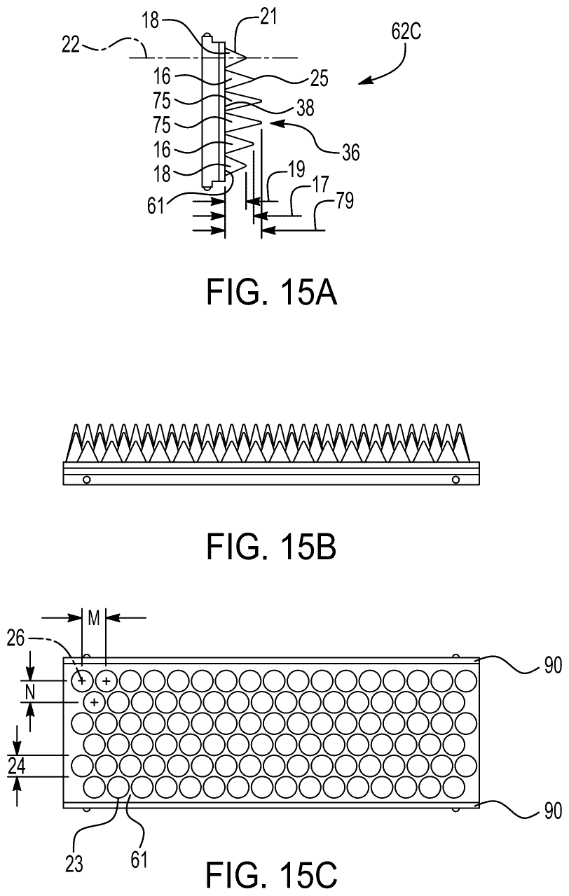

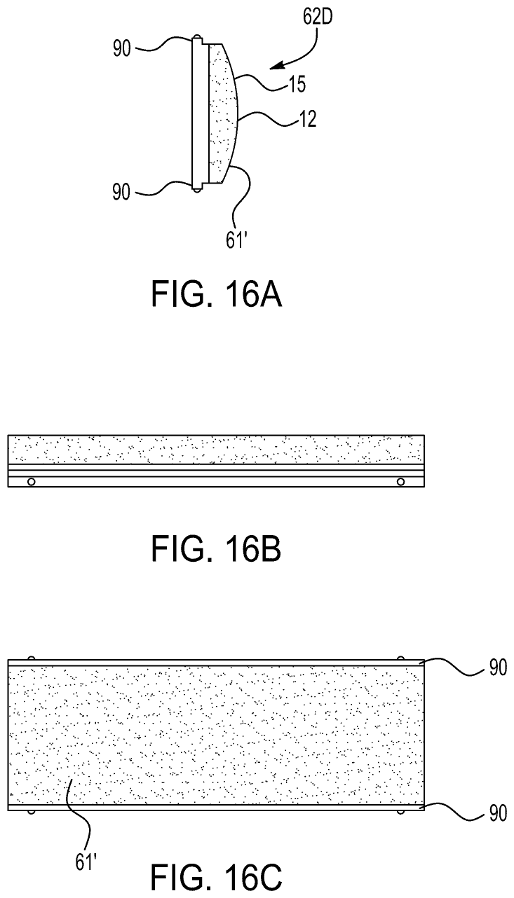

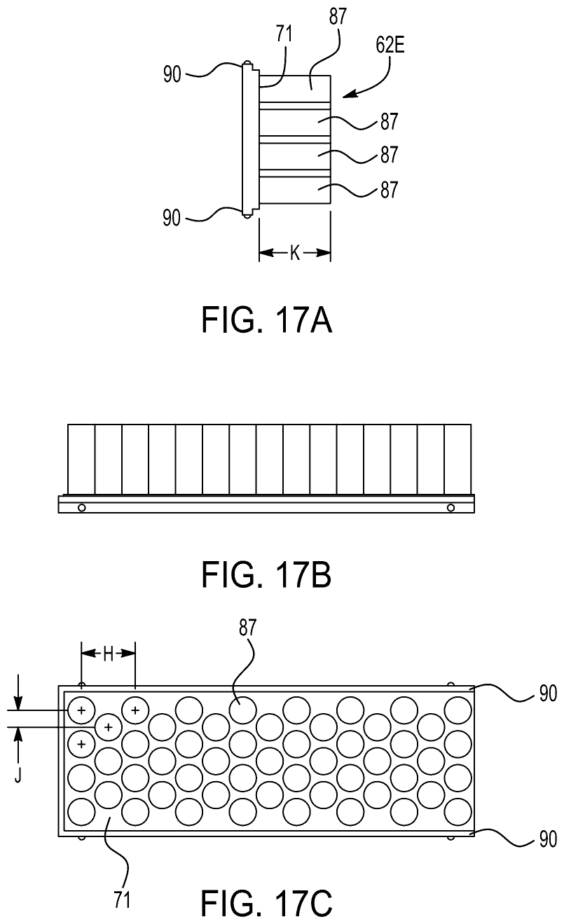

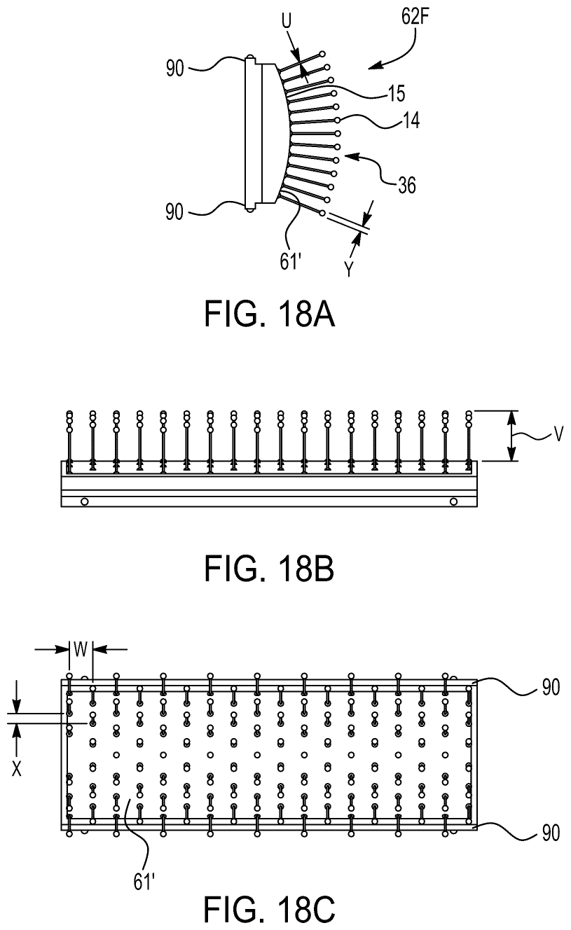

Examples of a combination sticky roller and brush are disclosed herein. The brush heads of the combination sticky roller and brush are interchangeable, making the combination versatile and suitable for a variety of animals. FIG. 12A through FIG. 12F respectively depict different examples of the interchangeable brush heads 62A through 62F. An example of interchangeable brush head 62A is shown in FIG. 12A, FIG. 13A, FIG. 13B, and FIG. 13C. An example of interchangeable brush head 62B is shown in FIG. 12B, FIG. 14A, FIG. 14B, and FIG. 14C. An example of interchangeable brush head 62C is shown in FIG. 12C, FIG. 15A, FIG. 15B, and FIG. 15C. An example of interchangeable brush head 62D is shown in FIG. 12D, FIG. 16A, FIG. 16B, and FIG. 16C. An example of interchangeable brush head 62E is shown in FIG. 12E, FIG. 17A, FIG. 17B, and FIG. 17C. An example of interchangeable brush head 62F is shown in FIG. 12F, FIG. 18A, FIG. 18B, and FIG. 18C. It is to be understood that reference numeral 62 is used to collectively refer to the interchangeable brush heads, and the reference numerals 62A, 62B, 62C, 62D, 62E, 62F refer to a specific one of the interchangeable brush heads. The brush heads 62 may be chosen for particular lint and hair removal tasks. The brush heads 62 may be provided in a kit, or as a set that includes some or all of the brush heads 62. In FIGS. 2, 4 and 6: view reference to “FIG. 13A-18A” means FIG. 13A, FIG. 14A, FIG. 15A, FIG. 16A, FIG. 17A and FIG. 18A; view reference to “FIG. 13B-18B” means FIG. 13B, FIG. 14B, FIG. 15B, FIG. 16B, FIG. 17B and FIG. 18B; view reference to “FIG. 13C-18C” means FIG. 13C, FIG. 14C, FIG. 15C, FIG. 16C, FIG. 17C and FIG. 18C. The kit may include any or all of the three frames 39, 40, 41 disclosed herein (see FIG. 1, FIG. 3, and FIG. 5). The kit may include a threaded handle 55 that may be interchangeably installed on any of the frames 39, 40, 41.

Brush head 62A may be most suitable for finer fabrics and fabrics that hair and fur cling to. The many smaller bristles help to grab the hair effectively. The attached ‘blade’ helps to sweep everything into a pile for the roller to pick up, as well as helping to dislodge any fur or hair that is not being dislodged by the brush. Brush head 62A also can be useful to loosen pet hair on short hair breeds, while providing a calming, gentle skin massage. Brush head 62A is recommended to be used in tandem with brush head 62E on the brush prior to the sticky roller clean-up and detailing. 62A may also be effective for grooming on sensitive skin areas around the face and underbellies.

Brush head 62B: With a wider spread and larger diameter bristles, brush head 62B is more effective on coarse or textured fabrics. While the slightly larger bristles help to dislodge and collect fur and hairs, the attached ‘blade’ helps to sweep everything into a pile for the roller to pick up, as well as helping to dislodge any fur or hair that is not being dislodged by the brush. Brush head 62B also can be useful to loosen pet hair on long hair breeds while providing a calming, gentle skin massage. Brush head 62B is recommended to be used in tandem with brush head 62F on the brush prior to the sticky roller clean-up and detailing. Brush head 62B may also be effective for grooming on sensitive skin areas around the face and underbellies.

Brush head 62C: With conical-shaped bristles, brush head 62C may be best for textured fabrics and fabrics similar to vehicle carpeting. Brush head 62C is suitable for dislodging fur and hair that has become interwoven and/or tangled in the fabric. Brush head 62C is also suitable for ‘sweeping’ loose debris into a pile for the roller to pick up.

Brush head 62D is made from a textured fabric. Brush head 62D has a directional use, meaning that the fabric that is adhered to the base is situated in a way that removes fur and hair when brushed in one direction, and does not remove fur and hair as effectively when used in the opposite direction. Brush head 62D may be suitable for use on smooth and delicate fabrics prior to using the sticky roller for clean- up and detailing.

Brush head 62E has coarse bristles that are more effective when used directly on a pet. Brush head 62E helps to dislodge and remove fur from both the undercoat and top coat of the pet. Brush head 62E is very effective on short and long coats of fur. Brush head 62E may still be used on fabrics, but brush head 62E may not be as effective as other brush heads (62A, 62B, 62C, 62F) on fabrics.

Brush head 62F is suitable for longer, thicker coats. Brush head 62F helps to dislodge and remove fur from the undercoat and top coat of fur while making the coat more aesthetically pleasing.

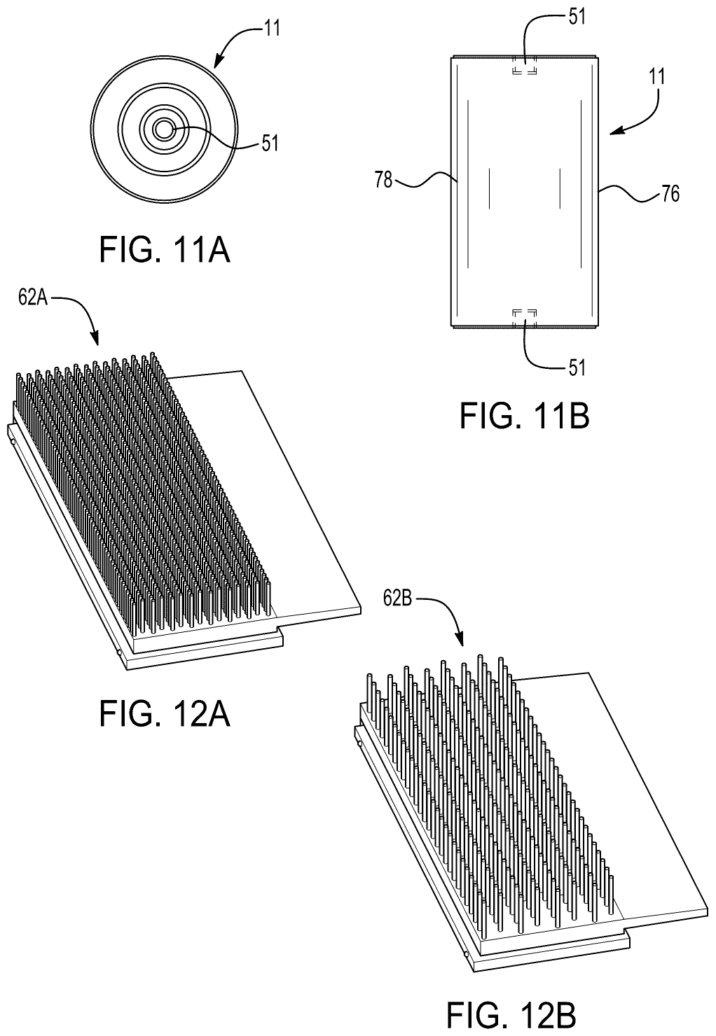

Referring to FIG. 1 and FIG. 2, an example of a combination sticky roller and brush is disclosed herein. In examples, the combination sticky roller and brush 10 includes a frame 40 including a first roller support flange 42 attached to a crossmember 44. A second roller support flange 46 may be attached to the crossmember 44, spaced apart from the first roller support flange 42. A first axle pin 48 may extend from first roller support flange 42. A second axle pin 50 may extend from the second roller support flange 46. A cylindrical roller 11 may have opposed ends 52, 53. A bearing 51 may be disposed on each of the opposed ends 52, 53 to respectively receive the first axle pin 48 and the second axle pin 50. The first axle pin 48 and the second axle pin 50 selectably retain the cylindrical roller 11 between the first roller support flange 42 and the second roller support flange 46. As used herein, “selectably retain” means retain in a way that is able to be chosen. In other words, a user may choose to remove and/or replace the cylindrical roller 11, but the cylindrical roller 11 will not inadvertently become unretained during normal use of the combination sticky roller and brush 10 for lint and hair removal. The cylindrical roller 11 may be rotatable about a roller axis of rotation 54 defined by the first axle pin 48 and the second axle pin 50. A handle 55 may be selectably attachable to the frame 40. As used herein, “selectably attachable” means attachable in a way that is able to be chosen. In other words, a user may choose to remove and/or replace the handle 55, but the handle 55 will not inadvertently become unattached during normal use of the combination sticky roller and brush 10 for lint and hair removal. The handle 55 may have a handle rotational axis of symmetry 56. The handle 55 may have a connecting end 58. The handle 55 may have a transverse hole 57 defined through the handle 55 distal to the connecting end 58. The transverse hole 57 may have a lanyard (not shown) or tether (not shown) introduced therethrough. The connecting end 58 may be complementary with a frame connector 60 defined on the frame 40. At least one groove 82 may be defined in the frame 40, parallel to the roller axis of rotation 54, wherein the at least one groove 82 may be to engage and selectably retain a brush head 62. The frame 40 and the brush head 62A, 62B, 62C, 62D, 62E, 62F together may define a latching mechanism 74 for selectably latching the brush head 62A, 62B, 62C, 62D, 62E, 62F in a service position (for example, as depicted in FIG. 1) and for resisting a predetermined threshold disengaging force. As used herein, “selectably latching” means latching in a way that is able to be chosen. In other words, a user may choose to latch or unlatch the brush head 62, and intentionally cause the brush head 62 to become latched or unlatched in the service position. It is to be understood that the latching mechanism 74 of the present disclosure does not inadvertently unlatch during normal use of the combination sticky roller and brush 10 for lint and hair removal. The cylindrical roller 11 may have a washable sticky layer 76 (see FIG. 11A) defined at a circumferential surface 78 of the cylindrical roller 11.

In examples, the handle rotational axis of symmetry 56 is parallel to the roller axis of rotation 54. In examples, the handle rotational axis of symmetry 56 is coaxial with the roller axis of rotation 54 when the handle 55 is attached to the frame 40. In examples, the handle 55 and the frame 40 may be configured to attach via a threaded joint 80 (see FIG. 1).

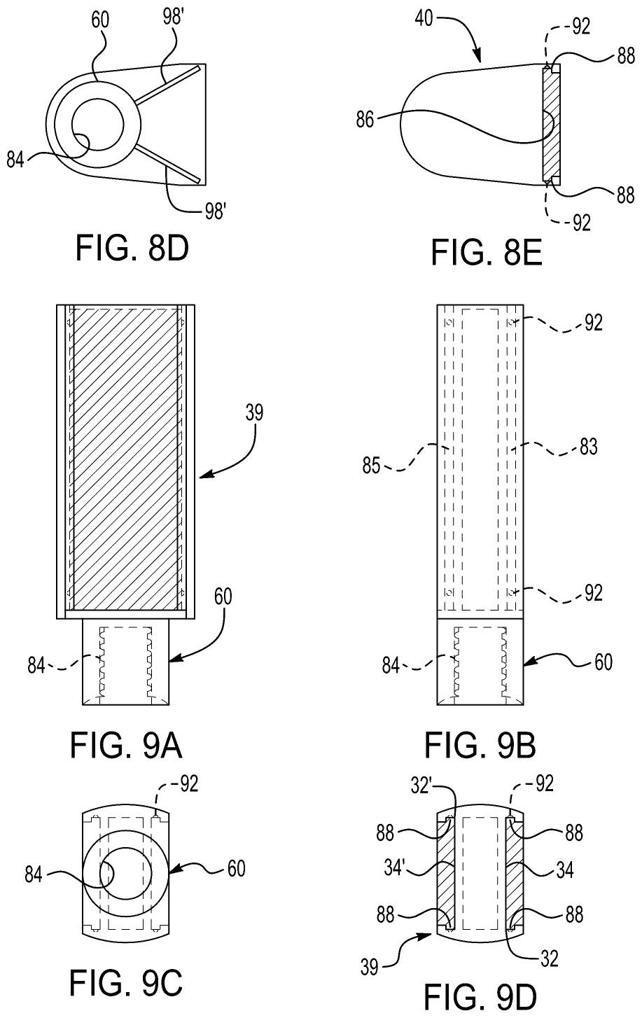

In examples, the frame connector 60 may include a threaded socket 84 (see FIG. 8A), and the connecting end 58 of the handle 55 may be threaded to be complementary to the threaded socket 84 to facilitate attaching the handle 55 to the frame 40 via the threaded joint 80. In examples, the threaded socket 84 may be co-molded with the first roller support flange 42. In examples, a gusset 98′ may support the frame connector 60 on the first roller support flange 42.

It is to be understood that, in examples, the handle 55 may be selectably attached to the frame 39, 40, 41, by any suitable means. Some examples of suitable attachment means include: bayonet fittings, friction lock fittings, pin/crosshole assembly, worm gear clamp, snap rings, or any other means for selectably attaching a shaft or tube to a body.

In examples, the bearings 51 may include plain bearings defined on each of the opposed ends 52, 53. In examples, the bearings may include bushings (not shown) inserted into each of the opposed ends 52, 53.

In examples, the at least one groove 82 includes a T-slot (not shown) defined in a brush head support face formed on the frame 40. The T-slot may include a central groove (not shown) defined parallel to the roller axis of rotation 54. The brush head 62A, 62B, 62C, 62D, 62E, 62F may include a T-slot engaging rail (not shown) to facilitate mounting the brush head 62A, 62B, 62C, 62D, 62E, 62F on the frame 40 by sliding the T-slot engaging rail into the T-slot.

In examples, the at least one groove 82 includes a pair of opposed, parallel peripheral grooves 88 (see FIG. 8E) defined at an edge of a recessed brush head support face 86 formed on the frame 40. The parallel peripheral grooves 88 may be defined parallel to the roller axis of rotation 54. The brush head 62A, 62B, 62C, 62D, 62E, 62F may include complementary flanges 90 (e.g., FIG. 13A) to engage the parallel peripheral grooves 88 to facilitate mounting the brush head 62A, 62B, 62C, 62D, 62E, 62F on the frame by sliding the complementary flanges 90 into the parallel peripheral grooves 88.

In examples, the latching mechanism 74 may include at least one detent 92 defined in the at least one groove 82 defined in the frame 40, and at least one complementary protrusion 94 to engage the at least one detent 92 and resist removal of the brush head 62A, 62B, 62C, 62D, 62E, 62F from the service position. An example of the service position is depicted in FIG. 1. In the service position, the brush head 62 is installed in the frame 40 and the latching mechanism 74 is engaged to selectably retain the brush head 62.

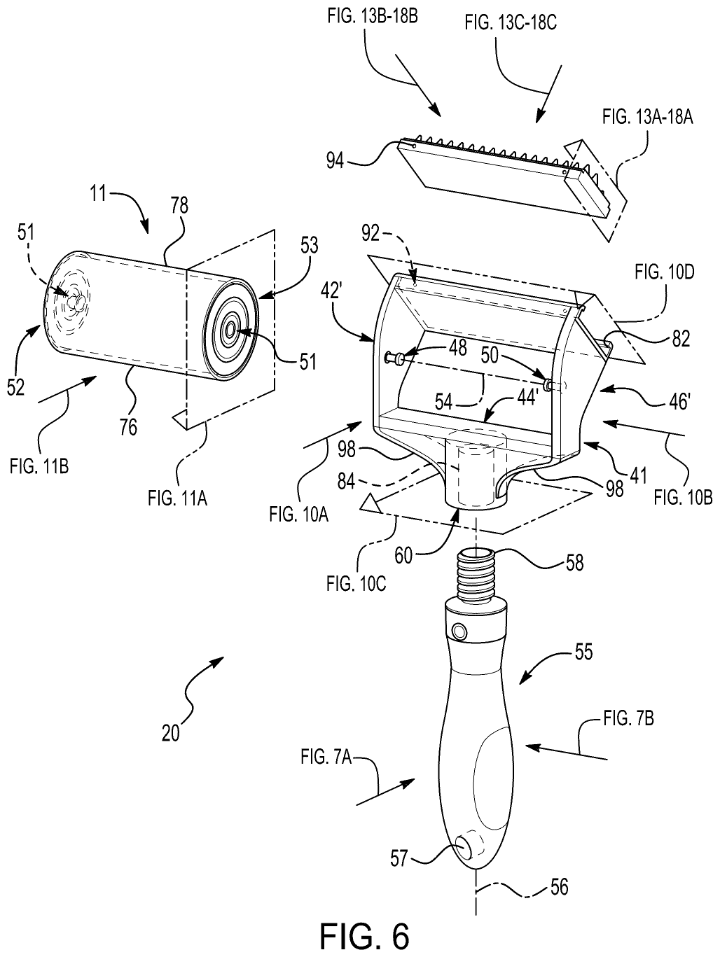

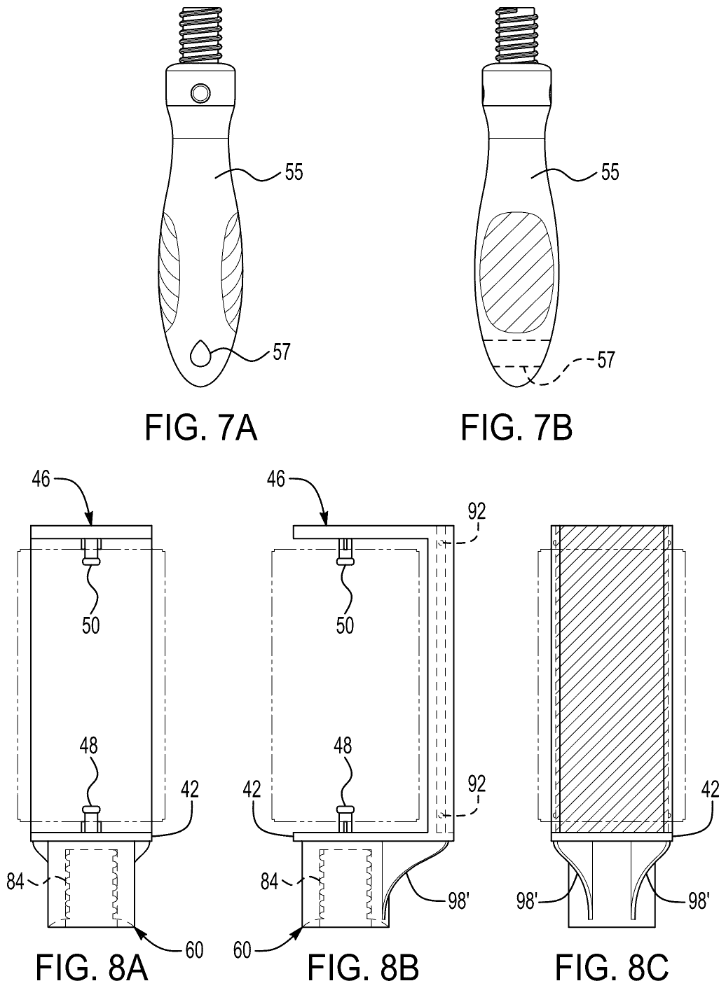

Referring to FIG. 5 and FIG. 6, another example of a combination sticky roller and brush is disclosed herein. In examples, the combination sticky roller and brush 20 includes a frame 41 including a first roller support flange 42′ attached to a crossmember 44′. A second roller support flange 46′ may be attached to the crossmember 44′, spaced apart from the first roller support flange 42′. A first axle pin 48 may extend from first roller support flange 42′. A second axle pin 50 may extend from the second roller support flange 46′. A cylindrical roller 11 may have opposed ends 52, 53. A bearing 51 may be disposed at each of the opposed ends 52, 53 to respectively receive the first axle pin 48 and the second axle pin 50. The first axle pin 48 and the second axle pin 50 selectably retain the cylindrical roller 11 between the first roller support flange 42 and the second roller support flange 46. The cylindrical roller 11 may be rotatable about a roller axis of rotation 54 defined by the first axle pin 48 and the second axle pin 50. A handle 55 may be selectably attachable to the frame 41. The handle 55 may have a handle rotational axis of symmetry 56. The handle 55 may have a connecting end 58. The connecting end 58 may be complementary with a frame connector 60 defined on the frame 41. At least one groove 82 may be defined in the frame 41, parallel to the roller axis of rotation 54, wherein the at least one groove 82 may be to engage and selectably retain a brush head 62A, 62B, 62C, 62D, 62E, 62F. The frame 41 and the brush head 62A, 62B, 62C, 62D, 62E, 62F together may define a latching mechanism 74 for selectably latching the brush head 62A, 62B, 62C, 62D, 62E, 62F in a service position (for example, as depicted in FIG. 5) and for resisting a predetermined threshold disengaging force. An example of the service position is depicted in FIG. 5. In the service position, the brush head 62 is installed in the frame 41 and the latching mechanism 74 is engaged to selectably retain the brush head 62. The cylindrical roller 11 may have a washable sticky layer 76 (see FIG. 11A) defined at a circumferential surface 78 of the cylindrical roller 11.

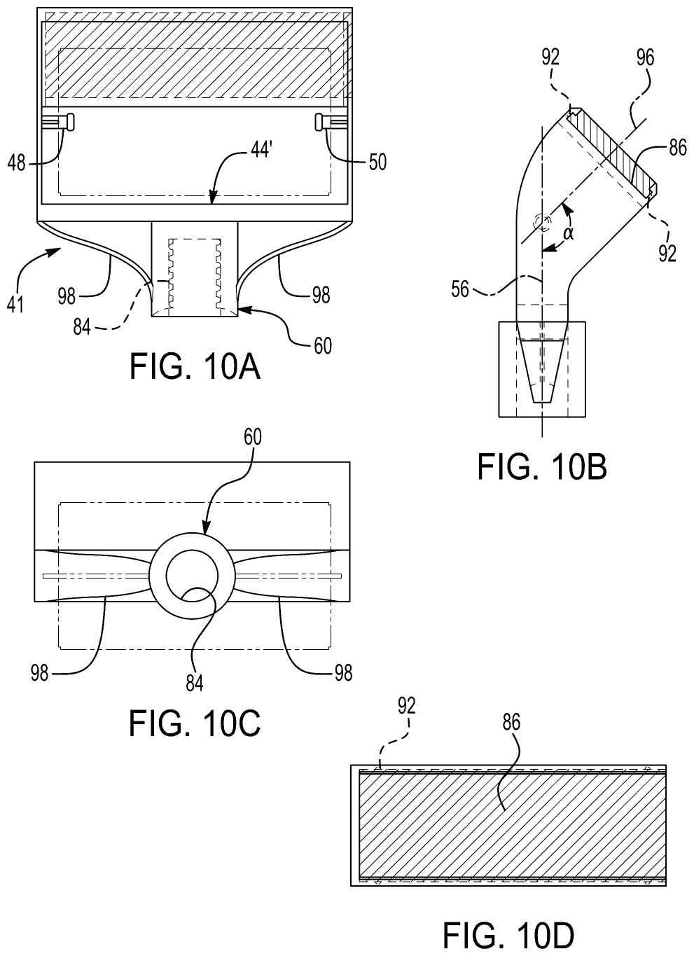

In examples, the handle rotational axis of symmetry 56 is orthogonal to the roller axis of rotation 54 when the handle 55 is attached to the frame 41. As used herein, two lines are “orthogonal” if the two lines are parallel to lines that meet at a right angle. In examples, the handle rotational axis of symmetry 56 is perpendicular to the roller axis of rotation 54 when the handle 55 is attached to the frame 41. As used herein, “perpendicular” means two lines meet at a right angle. In examples, the handle 55 and the frame 41 are configured to attach via a threaded joint 80 (see FIG. 5). In examples, an angle α between a line 96 extended normal to a recessed brush head support face 86 and the handle rotational axis of symmetry 56 is about 135 degrees. (See, e.g., FIG. 10B.)

In examples the threaded socket 84 may be co-molded with the crossmember 44′ and a gusset 98 may support the threaded socket 84 on the crossmember 44′. In the example depicted in FIG. 6, two gussets 98 support the threaded socket 84 on the crossmember 44′.

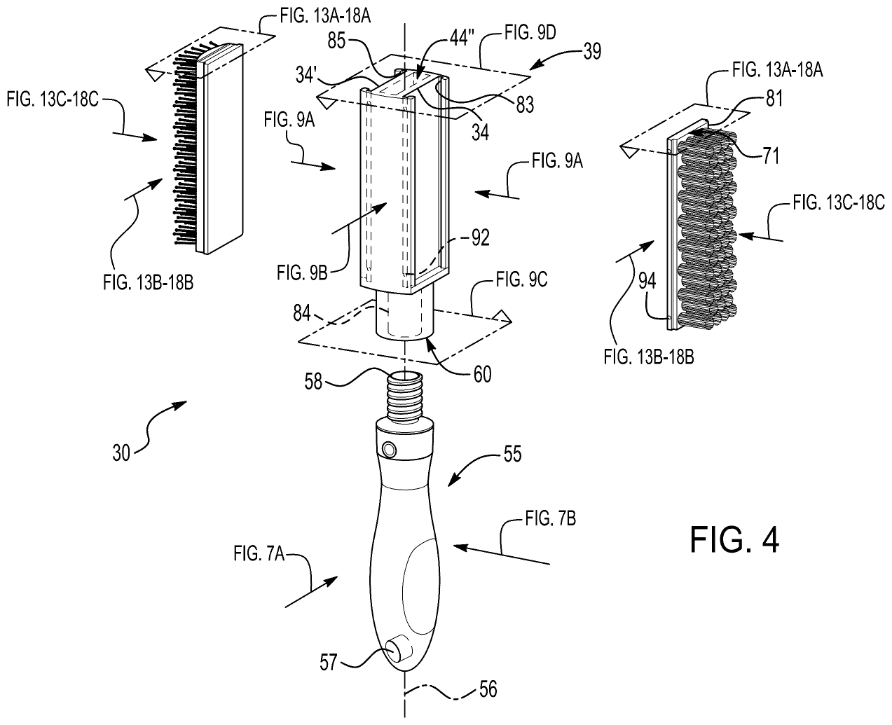

Referring to FIG. 3 and FIG. 4, an example of a modular bimodal brush 30 is disclosed herein. In examples, the modular bimodal brush 30 includes a frame 39. The frame 39 may include a crossmember 44″. A handle 55 may be selectably attachable to the frame 39. The handle 55 may have a handle rotational axis of symmetry 56. The handle 55 may have a connecting end 58. The connecting end 58 may be complementary with a frame connector 60 defined on the frame 39. At least one first brush head retention groove 83 may be defined in the frame 39, parallel to the handle rotational axis of symmetry 56. The at least one first brush head retention groove 83 may be to engage and selectably retain a first brush head 62E. The frame 39 and first brush head 62E together define a first latching mechanism 74′ for selectably latching the first brush head in a first service position (for example, as depicted in FIG. 3) and for resisting a predetermined threshold disengaging force. At least one second brush head retention groove 85 may be defined in the frame 39, parallel to the handle rotational axis of symmetry 56. The at least one second brush head retention groove 85 may be to engage and selectably retain a second brush head 62F. The frame 39 and second brush head 62F together define a second latching mechanism 74″ for selectably latching the second brush head 62F in a second service position (for example, as depicted in FIG. 3) and for resisting the predetermined threshold disengaging force. An example of the service positions is depicted in FIG. 3. In the service positions, the brush heads 62E, 62F are installed in the frame 39 and the latching mechanisms 74′, 74″ are engaged to selectably retain the brush heads 62E, 62F.

In examples, the at least one first brush head retention groove 83 includes a first pair of opposed, parallel peripheral grooves 88 (see FIG. 9D) defined at a first edge 32 of a first recessed brush head support face 34 formed on the frame 39. The first pair of opposed, parallel peripheral grooves 88 may be defined parallel to the handle rotational axis of symmetry 56. The first brush head 62E may include first complementary flanges 90 (See FIG. 17A) to engage the first pair of opposed, parallel peripheral grooves 88 to facilitate mounting the first brush head 62E on the frame 39 by sliding the first complementary flanges 90 into the first pair of opposed, parallel peripheral grooves 88. The at least one second brush head retention groove 85 includes a second pair of opposed, parallel peripheral grooves 88 defined at a second edge 32′ of a second recessed brush head support face 34′ formed on the frame 39. The second pair of parallel peripheral grooves 88 may be defined parallel to the handle rotational axis of symmetry 56. The second brush head 62F may include second complementary flanges 90 (See FIG. 18A) to engage the second pair of opposed, parallel peripheral grooves 88 to facilitate mounting the second brush head on the frame 39 by sliding the second complementary flanges 90 into the second pair of opposed, parallel peripheral grooves 88. The first brush head 62E is mountable in the second pair of opposed, parallel peripheral grooves 88, and wherein the second brush head 62F is mountable in the first pair of opposed, parallel peripheral grooves. As such, the first brush head 62E and the second brush head 62F are interchangeable on the frame 39. It is to be understood that the brush heads 62A, 62B, 62C, 62D, 62E, and 62F are each interchangeable in the frame 39. It is optional to select and install any of the brush heads 62 in the frame 39 in either the first recessed brush head support face 34 or the second recessed brush head support face 34′ formed on the frame 39. In examples, the two brush heads may be two instances of the same brush head 62A, 62B, 62C, 62D, 62E, or 62F.

Referring to FIG. 4, FIG. 12E, FIG. 17A, 17B, and 17C, in examples, the first brush head 62E may have a first brush head bed 71 with a first planar surface 81 distal to the first recessed brush head support face 34. In examples, a plurality of first bristles not shown individually, gathered into tufts 87, extend from the first brush head bed 71, wherein the tufts 87 are attached to the first brush head bed 71 in rows (see FIG. 17C) in a planar rhombic lattice. As shown in FIG. 17C, the tufts 87 may be spaced about H= 9/16 inch on centers in rows that are spaced J= 3/16 inch on centers. The first bristles extend about K=¾ inch from the first brush head bed 71.

Referring to FIG. 4, FIG. 12B, FIG. 14A, 14B, and 14C, in examples, the second brush head 62B, may have a second brush head bed 61 with a second planar surface 38 distal to the second recessed brush head support face 34′. A plurality of second bristles 36 extend from the second brush head bed 61. As shown in FIG. 14C, second bristles 36 may be substantially cylindrical having a diameter of about A= 1/16 inch and a length of about B= 13/32 inch, wherein the second bristles 36 are spaced about C= 5/32 inch on centers in rows that are spaced D= 3/16 inch on centers. The second brush head 62B may have a second blade 28 defined along an edge of the second brush head bed 61. The second blade 28 may project about E= 13/16 inch from the edge of the second brush head bed 61. The second blade 28 may have a trapezoidal cross-section as seen in FIG. 14A, with a base thickness of about F=⅛ inch and a minor edge thickness of about G= 1/16 inch. The second blade 28 may be void of the second bristles. The second blade 28 may be void of any bristles.

Referring to FIG. 4, FIG. 12C, FIG. 15A, 15B, and 15C, in examples: the second brush head 62C has a second brush head bed 61 with a second planar surface 38 distal to the second recessed brush head support face 34′, a plurality of second bristles 36 extend from the second brush head bed 61. The second bristles 36 have a conical surface 21, each second bristle having an axis 22, a circular base 23 having a base diameter 24, and a bristle vertex 25. Each axis 22 may be normal to the second planar surface 38 of the second brush head bed 61. Each bristle vertex 25 intersects a respective base center 26, and the base centers 26 are arranged in a planar rhombic lattice. Each base diameter 24 is about 7/32 inch. The second bristles 36 may be spaced about M=¼ inch on centers in rows that are spaced N= 7/32 inch on centers. The rows include a tall row 75. The second bristles 36 in the tall row 75 have a first height 79. The rows include a medium row 16. The second bristles 36 in the medium row 16 have a second height 17. The rows include a short row 18. The second bristles in the short row 18 have third height 19. The first height 79 is about 13/32 inch. The second height 17 is about 5/16 inch. The third height 19 is about 7/32 inch. The tall rows 75 are each adjacent to a tall row 75 and a respective medium row 16. The short rows 18 are each adjacent to a respective medium row 16.

Referring to FIG. 4, FIG. 12D, FIG. 16A, 16B, and 16C, in examples, the second brush head 62D has a second brush head bed 61′. The second brush head bed 61′ includes a surface defining a cylindrical segment 15. The second brush head bed 61′ is distal to the second recessed brush head support face 34′. A fabric cover 12 is attached to the second brush head bed 61′. The fabric cover 12 includes a directional nap (not shown). The directional nap is configured to remove fur and hair when brushed in a first direction against a surface having fur or hair thereon. When the directional nap is brushed in a second direction opposite the first direction, the fur and hair remain on the surface having fur or hair thereon.

Referring to FIG. 4, FIG. 12A, FIG. 13A, 13B, and 13C, in examples, the second brush head 62A, may have a second brush head bed 61 with a second planar surface 38 distal to the second recessed brush head support face 34′. A plurality of bristles 36 may extend from the second brush head bed 61. As shown in FIG. 13C, the second bristles 36 are substantially cylindrical having a diameter of about P= 1/32 inch and a length of about Q= 13/32 inch (FIG. 13A), wherein the second bristles 36 are spaced about R= 3/32 inch on centers in rows that are spaced about S= 3/32 inch on centers. The second brush head 62A may have a second blade 28 defined along an edge of the second brush head bed 61. The second blade projects about T= 13/16 inch from the edge of the second brush head bed 61. The second blade 28 may have a trapezoidal cross-section as seen in FIG. 13A, with a base thickness of about F=⅛ inch and a minor edge thickness of about G= 1/16 inch. The second blade 28 may be void of the second bristles. The second blade 28 may be void of any bristles.

Referring to FIG. 4, FIG. 12F, FIG. 18A, 18B, and 18C, in examples, the second brush head 62F has a second brush head bed 61′. The second brush head bed 61′ includes a surface defining a cylindrical segment 15. The second brush head bed 61′ is distal to the second recessed brush head support face 34′. A plurality of second bristles 36 extends from the second brush head bed 61′. The second bristles 36 may be cylindrical having a diameter of about U= 1/64 inch and a length of about V= 17/32 inch, wherein each second bristle 36 is normal to the surface defining the cylindrical segment 15. The second bristles 36 are spaced about W=¼ inch on centers in rows that are spaced about X=⅛ inch on centers at the surface defining the cylindrical segment 15. Each second bristle 36 has a ball end 14 affixed to an end of the respective second bristle, wherein the ball end 14 has a diameter of about Y= 1/32 inch.

It is to be understood that certain ordinal terms (e.g., “first” or “second”) may be provided herein for ease of reference and do not necessarily imply physical characteristics or ordering. Therefore, as used herein, an ordinal term (e.g., “first,” “second,” “third,” etc.) used to modify an element, such as a structure, a component, an operation, etc., does not necessarily indicate priority or order of the element with respect to any other element, but rather may generally distinguish the element from another element having a similar or identical name (but for use of the ordinal term).

It is to be understood that variation in the dimensions provided herein is contemplated. Manufacturing tolerances and variation is disclosed herein. Further, scaling of the components of the present disclosure both up and down is disclosed herein. Addition or subtraction of rows or columns of bristles is disclosed herein.

It is to be understood that any combination of features from the aspects and examples disclosed herein may be used together, and/or that any features from any or all of these aspects may be combined with any of the features of the examples disclosed herein to achieve the benefits as described in this disclosure. For example, any of the brush heads may be used as the “first brush head” and combined with any of the brush heads described as the “second brush head” above. It is to be understood that each of these combinations of brush heads is contemplated by the inventors of the present disclosure and disclosed herein by this reference.

Reference throughout the specification to “one example”, “another example”, “an example”, “example of,” and so forth, means that a particular element (e.g., feature, structure, and/or characteristic) described in connection with the example is included in at least one example described herein, and may or may not be present in other examples. In addition, it is to be understood that the described elements for any example may be combined in any suitable manner in the various examples unless the context clearly dictates otherwise.

It is to be understood that the ranges provided herein include the stated range and any value or sub-range within the stated range. For example, a range from about ¼ inch to about ½ inch should be interpreted to include the explicitly recited limits of about ¼ inch to about ½ inch, as well as individual values, such as ¼ inch, 0.375 inch, ½ inch, etc., and sub-ranges, such as from about ¼ inch to about ⅜ inch, etc. Furthermore, when “about” is utilized to describe a value, this is meant to encompass minor variations (up to +/−10%) from the stated value.

In describing and claiming the examples disclosed herein, the singular forms “a”, “an”, and “the” include plural referents unless the context clearly dictates otherwise.

While several examples have been described in detail, it is to be understood that the disclosed examples may be modified. Therefore, the foregoing description is to be considered non-limiting.

What is claimed is:

1. A combination sticky roller and brush, comprising:
a frame including a first roller support flange attached to a crossmember and a second roller support flange attached to the crossmember spaced apart from the first roller support flange;
a first axle pin extending from first roller support flange;
a second axle pin extending from the second roller support flange;
a cylindrical roller having opposed ends;
a bearing disposed on each of the opposed ends to respectively receive the first axle pin and the second axle pin, wherein the first axle pin and the second axle pin selectably retain the cylindrical roller between the first roller support flange and the second roller support flange, and wherein the roller is rotatable about a roller axis of rotation defined by the first axle pin and the second axle pin;
a handle, selectably attachable to the frame, the handle having a handle rotational axis of symmetry, the handle having a connecting end, the connecting end complementary with a frame connector defined on the frame; and
at least one groove defined in the frame, parallel to the roller axis of rotation, wherein the at least one groove is to engage and selectably retain a brush head, wherein the frame and the brush head together define a latching mechanism for selectably latching the brush head in a service position and for resisting a predetermined threshold disengaging force;
wherein the cylindrical roller has a washable sticky layer defined at a circumferential surface of the cylindrical roller.

2. The combination sticky roller and brush as defined in claim 1 wherein the handle rotational axis of symmetry is parallel to the roller axis of rotation.

3. The combination sticky roller and brush as defined in claim 2 wherein the handle rotational axis of symmetry is coaxial with the roller axis of rotation when the handle is attached to the frame.

4. The combination sticky roller and brush as defined in claim 3 wherein the handle and the frame are configured to attach via a threaded joint.

5. The combination sticky roller and brush as defined in claim 1 wherein the handle rotational axis of symmetry is orthogonal to the roller axis of rotation when the handle is attached to the frame.

6. The combination sticky roller and brush as defined in claim 5 wherein the handle rotational axis of symmetry is perpendicular to the roller axis of rotation when the handle is attached to the frame.

7. The combination sticky roller and brush as defined in claim 6 wherein the handle and the frame are configured to attach via a threaded joint.

8. The combination sticky roller and brush as defined in claim 1 wherein the frame connector includes a threaded socket, and the connecting end of the handle is threaded to be complementary to the threaded socket to facilitate attaching the handle to the frame via a threaded joint.

9. The combination sticky roller and brush as defined in claim 1 wherein the bearings include plain bearings defined in hubs defined on each of the opposed ends.

10. The combination sticky roller and brush as defined in claim 1 wherein the at least one groove includes a T-slot defined in a brush head support face formed on the frame, wherein the T-slot includes a central groove defined parallel to the roller axis of rotation; wherein the brush head includes a T-slot engaging rail to facilitate mounting the brush head on the frame by sliding the T-slot engaging rail into the T-slot.

11. The combination sticky roller and brush as defined in claim 1 wherein the at least one groove includes a pair of opposed, parallel peripheral grooves defined at an edge of a recessed brush head support face formed on the frame, wherein the parallel peripheral grooves are defined parallel to the roller axis of rotation; wherein the brush head includes complementary flanges to engage the parallel peripheral grooves to facilitate mounting the brush head on the frame by sliding the complementary flanges into the parallel peripheral grooves.

12. The combination sticky roller and brush as defined in claim 5 wherein an angle between a line extended normal to a recessed brush head support face and the handle rotational axis of symmetry is about 135 degrees.

13. The combination sticky roller and brush as defined in claim 1 wherein the latching mechanism includes at least one detent defined in the at least one groove defined in the frame, and at least one complementary protrusion to engage the at least one detent and resist removal of the brush head from the service position.

14. The combination sticky roller and brush as defined in claim 1 wherein the brush head has a brush head bed with a planar surface distal to a brush head support face formed in the frame, wherein a plurality of bristles extend from the brush head bed, wherein the bristles are substantially cylindrical having a diameter of about 1/32 inch and a length of about 13/32 inch, wherein the bristles are spaced about 3/32 inch on centers in rows that are spaced 3/32 inch on centers, wherein the brush head has a blade defined along an edge of the brush head bed, wherein the blade projects about 13/16 inch from the edge of the brush head bed, wherein the blade has a trapezoidal cross-section with a base thickness of about ⅛ inch and a minor edge thickness of about 1/16 inch, wherein the blade is void of the bristles.

15. The combination sticky roller and brush as defined in claim 1 wherein the brush head has a brush head bed with a planar surface distal to a brush head support face formed in the frame, wherein a plurality of bristles extend from the brush head bed, wherein the bristles are substantially cylindrical having a diameter of about 1/16 inch and a length of about 13/32 inch, wherein the bristles are spaced about 5/32 inch on centers in rows that are spaced 3/16 inch on centers, wherein the brush head has a blade defined along an edge of the brush head bed, wherein the blade projects about 13/16 inch from the edge of the brush head bed, wherein the blade has a trapezoidal cross-section with a base thickness of about ⅛ inch and a minor edge thickness of about 1/16 inch, wherein the blade is void of the bristles.

16. The combination sticky roller and brush as defined in claim 1 wherein:
the brush head has a brush head bed with a planar surface distal to a brush head support face formed in the frame,
a plurality of bristles extend from the brush head bed
the bristles have a conical surface, each bristle having a bristle axis, a circular base having a base diameter, and a bristle vertex,
each bristle axis is normal to the planar surface of the brush head bed,
each bristle vertex intersects a respective base center, and the base centers are arranged in a planar rhombic lattice,
each base diameter is about 7/32 inch,
the bristles are spaced about ¼ inch on centers in rows that are spaced 7/32 inch on centers,
the rows include a tall row,
the bristles in the tall row have a first height,
the rows include a medium row
the bristles in the medium row have a second height,
the rows include a short row
the bristles in the short row have third height,
the first height is about 13/32 inch,
the second height is about 5/16 inch,
the third height is about 7/32 inch,
the tall rows are each adjacent to a tall row and a respective medium row, and
the short rows are each adjacent to a respective medium row.

17. The combination sticky roller and brush as defined in claim 1 wherein the brush head has a brush head bed, wherein the brush head bed includes a surface defining a cylindrical segment, wherein the brush head bed is distal to a brush head support face formed in the frame, wherein a fabric cover is attached to the brush head bed, wherein the fabric cover includes a directional nap, wherein the directional nap is configured to remove fur and hair when brushed in a first direction against a surface having fur or hair thereon, wherein, when brushed in a second direction opposite the first direction, the fur and hair remain on the surface having fur or hair thereon.

18. The combination sticky roller and brush as defined in claim 1 wherein the brush head has a brush head bed with a planar surface distal to a brush head support face formed in the frame, wherein a plurality of bristles, gathered into tufts, extend from the brush head bed, wherein the tufts are attached to the brush head bed in rows in a planar rhombic lattice, wherein the tufts are spaced about 9/16 on centers in rows that are spaced 3/16 on centers, wherein the bristles extend about ¾ inch from the brush head bed.

19. The combination sticky roller and brush as defined in claim 1 wherein the brush head has a brush head bed, wherein the brush head bed includes a surface defining a cylindrical segment, wherein the brush head bed is distal to a brush head support face formed in the frame, wherein a plurality of bristles extend from the brush head bed, wherein the bristles are cylindrical having a diameter of about 1/64 inch and a length of about 17/32 inch, wherein each bristle is normal to the surface defining the cylindrical segment, wherein the bristles are spaced about ¼ inch on centers in rows that are spaced about ⅛ inch on centers at the surface defining the cylindrical segment, wherein each bristle has a ball end affixed to an end of the respective bristle, wherein the ball end has a diameter of about 1/32 inch.

20. A modular bimodal brush, comprising:
a frame including a crossmember;
a handle, selectably attachable to the frame, the handle having a handle rotational axis of symmetry, the handle having a connecting end, the connecting end complementary with a frame connector defined on the frame;
at least one first brush head retention groove defined in the frame, parallel to the handle rotational axis of symmetry, wherein the at least one first brush head retention groove is to engage and selectably retain a first brush head, wherein the frame and first brush head together define a first latching mechanism for selectably latching the first brush head in a first service position and for resisting a predetermined threshold disengaging force; and
at least one second brush head retention groove defined in the frame, parallel to the handle rotational axis of symmetry, wherein the at least one second brush head retention groove is to engage and selectably retain a second brush head, wherein the frame and second brush head together define a second latching mechanism for selectably latching the second brush head in a second service position and for resisting the predetermined threshold disengaging force.

21. The modular bimodal brush as defined in claim 20 wherein the at least one first brush head retention groove includes a first pair of opposed, parallel peripheral grooves defined at a first edge of a first recessed brush head support face formed on the frame, wherein the first pair of parallel peripheral grooves is defined parallel to the handle rotational axis of symmetry; wherein the first brush head includes first complementary flanges to engage the first pair of parallel peripheral grooves to facilitate mounting the first brush head on the frame by sliding the first complementary flanges into the first pair of parallel peripheral grooves;
wherein the at least one second brush head retention groove includes a second pair of opposed, parallel peripheral grooves defined at a second edge of a second recessed brush head support face formed on the frame, wherein the second pair of parallel peripheral grooves is defined parallel to the handle rotational axis of symmetry; wherein the second brush head includes second complementary flanges to engage the second pair of parallel peripheral grooves to facilitate mounting the second brush head on the frame by sliding the second complementary flanges into the second pair of parallel peripheral grooves,
wherein the first brush head is mountable in the second pair of parallel peripheral grooves, and wherein the second brush head is mountable in the first pair of parallel peripheral grooves.

22. The modular bimodal brush as defined in claim 21 wherein the first brush head has a first brush head bed with a first planar surface distal to the first recessed brush head support face, wherein a plurality of first bristles extend from the first brush head bed, wherein the first bristles are substantially cylindrical having a diameter of about 1/32 inch and a length of about 13/32 inch, wherein the first bristles are spaced about 3/32 inch on centers in rows that are spaced 3/32 inch on centers, wherein the first brush head has a first blade defined along an edge of the first brush head bed, wherein the first blade projects about 13/16 inch from the first edge of the first brush head bed, wherein the first blade has a trapezoidal cross-section with a base thickness of about ⅛ inch and a minor edge thickness of about 1/16 inch, wherein the first blade is void of the first bristles.

23. The modular bimodal brush as defined in claim 21 wherein the second brush head has a second brush head bed with a second planar surface distal to the second recessed brush head support face, wherein a plurality of second bristles extend from the second brush head bed, wherein the second bristles are substantially cylindrical having a diameter of about 1/16 inch and a length of about 13/32 inch, wherein the second bristles are spaced about 5/32 inch on centers in rows that are spaced 3/16 inch on centers, wherein the second brush head has a second blade defined along an edge of the second brush head bed, wherein the second blade projects about 13/16 inch from the edge of the second brush head bed, wherein the second blade has a trapezoidal cross-section with a base thickness of about ⅛ inch and a minor edge thickness of about 1/16 inch, wherein the second blade is void of the second bristles.

24. The modular bimodal brush as defined in claim 21 wherein:
the second brush head has a second brush head bed with a second planar surface distal to the second recessed brush head support face,
a plurality of second bristles extend from the second brush head bed
the second bristles have a conical surface, each second bristle having an axis, a circular base having a base diameter, and a bristle vertex,
each axis is normal to the second planar surface of the second brush head bed,
each bristle vertex intersects a respective base center, and the base centers are arranged in a planar rhombic lattice,
each base diameter is about 7/32 inch,
the second bristles are spaced about ¼ inch on centers in rows that are spaced 7/32 inch on centers,
the rows include a tall row,
the second bristles in the tall row have a first height,
the rows include a medium row
the second bristles in the medium row have a second height,
the rows include a short row
the second bristles in the short row have third height,
the first height is about 13/32 inch,
the second height is about 5/16 inch,
the third height is about 7/32 inch,
the tall rows are each adjacent to a tall row and a respective medium row, and
the short rows are each adjacent to a respective medium row.

25. The modular bimodal brush as defined in claim 21 wherein the second brush head has a second brush head bed, wherein the second brush head bed includes a surface defining a cylindrical segment, wherein the second brush head bed is distal to the second recessed brush head support face, wherein a fabric cover is attached to the second brush head bed, wherein the fabric cover includes a directional nap, wherein the directional nap is configured to remove fur and hair when brushed in a first direction against a surface having fur or hair thereon, wherein, when brushed in a second direction opposite the first direction, the fur and hair remain on the surface having fur or hair thereon.

26. The modular bimodal brush as defined in claim 21 wherein the second brush head has a second brush head bed with a second planar surface distal to the second recessed brush head support face, wherein a plurality of second bristles, gathered into tufts, extend from the second brush head bed, wherein the tufts are attached to the second brush head bed in rows in a planar rhombic lattice, wherein the tufts are spaced about 9/16 inch on centers in rows that are spaced 3/16 inch on centers, wherein the second bristles extend about ¾ inch from the second brush head bed.

27. The modular bimodal brush as defined in claim 21 wherein the second brush head has a second brush head bed, wherein the second brush head bed includes a surface defining a cylindrical segment, wherein the second brush head bed is distal to the second recessed brush head support face, wherein a plurality of second bristles extends from the second brush head bed, wherein the second bristles are cylindrical having a diameter of about 1/64 inch and a length of about 17/32 inch, wherein each second bristle is normal to the surface defining the cylindrical segment, wherein the second bristles are spaced about ¼ inch on centers in rows that are spaced about ⅛ inch on centers at the surface defining the cylindrical segment, wherein each second bristle has a ball end affixed to an end of the respective second bristle, wherein the ball end has a diameter of about 1/32 inch.

28. A kit for removing lint and hair from a surface, the kit comprising:
at least one first frame, a cylindrical roller, a handle and at least two brush heads selected from the group consisting of: a first brush head, a second brush head, a third brush head, a fourth brush head, a fifth brush head and a sixth brush head;
wherein the at least one first frame includes:
a first roller support flange attached to a first crossmember and a second roller support flange attached to the first crossmember spaced apart from the first flange;
a first axle pin extending from first roller support flange; and
a second axle pin extending from the second roller support flange; wherein the cylindrical roller includes:
opposed ends;
a washable sticky layer defined at a circumferential surface of the cylindrical roller; and
a bearing disposed on each of the opposed ends to respectively receive the first axle pin and the second axle pin, wherein the first axle pin and the second axle pin selectably retain the cylindrical roller between the first roller support flange and the second roller support flange, and wherein the roller is rotatable about a roller axis of rotation defined by the first axle pin and the second axle pin;
wherein the handle is selectably attachable to the at least one first frame, the handle having a handle rotational axis of symmetry, the handle having a connecting end, the connecting end complementary with a frame connector defined on the at least one first frame;
wherein at least one groove is defined in the at least one first frame, parallel to the roller axis of rotation, wherein the at least one groove is to engage and selectably retain a first of the at least two brush heads, wherein the at least one first frame and the first of the at least two brush heads together define a first latching mechanism for selectably latching the first of the at least two brush heads in a first service position and for resisting a predetermined threshold disengaging force;
wherein the first brush head has a first brush head bed with a first planar surface distal to a brush head support face formed in the at least one first frame, wherein a first plurality of first bristles extend from the first brush head bed, wherein the first bristles are substantially cylindrical having a diameter of about 1/32 inch and a length of about 13/32, wherein the first bristles are spaced about 3/32 inch on centers in rows that are spaced 3/32 inch on centers, wherein the first brush head has a first blade defined along an edge of the first brush head bed, wherein the first blade projects about 13/16 inch from the edge of the first brush head bed, wherein the first blade has a trapezoidal cross-section with a first base thickness of about ⅛ inch and a first minor edge thickness of about 1/16 inch, wherein the first blade is void of the first bristles;
wherein the second brush head has a second brush head bed with a second planar surface distal to a brush head support face formed in the at least one first frame, wherein a second plurality of second bristles extend from the second brush head bed, wherein the second bristles are substantially cylindrical having a second bristle diameter of about 1/16 inch and a second bristle length of about 13/32 inch, wherein the second bristles are spaced about 5/32 inch on centers in rows that are spaced 3/16 inch on centers, wherein the second brush head has a second blade defined along an edge of the second brush head bed, wherein the second blade projects about 13/16 inch from the edge of the second brush head bed, wherein the second blade has a trapezoidal cross-section with a base thickness of about ⅛ inch and a minor edge thickness of about 1/16 inch, wherein the second blade is void of the second bristles;
wherein: the third brush head has a third brush head bed with a third planar surface distal to a brush head support face formed in the at least one first frame; a plurality of third bristles extend from the third brush head bed; the third bristles have a conical surface, each third bristle having an axis, a circular base having a third base diameter, and a third bristle vertex; each third bristle axis is normal to the third planar surface of the third brush head bed; each third bristle vertex intersects a respective base center, and the base centers are arranged in a planar rhombic lattice; each base diameter is about 7/32 inch; the third bristles are spaced about ¼ inch on centers in rows that are spaced 7/32 inch on centers; the rows include a tall row; the third bristles in the tall row have a first height; the rows include a medium row; the third bristles in the medium row have a second height; the rows include a short row; the third bristles in the short row have third height; the first height is about 13/32 inch; the second height is about 5/16 inch; the third height is about 7/32 inch; the tall rows are each adjacent to a tall row and a respective medium row; and the short rows are each adjacent to a respective medium row;
wherein the fourth brush head has a fourth brush head bed, wherein the fourth brush head bed includes a fourth surface defining a fourth cylindrical segment, wherein the fourth brush head bed is distal to a brush head support face formed in the at least one first frame, wherein a fabric cover is attached to the fourth brush head bed, wherein the fabric cover includes a directional nap, wherein the directional nap is configured to remove fur and hair when brushed in a first direction against a surface having fur or hair thereon, wherein, when brushed in a second direction opposite the first direction, the fur and hair remain on the surface having fur or hair thereon;
wherein the fifth brush head has a fifth brush head bed with a fifth planar surface distal to a brush head support face formed in the at least one first frame, wherein a plurality of fifth bristles, gathered into tufts, extend from the fifth brush head bed, wherein the tufts are attached to the fifth brush head bed in rows in a planar rhombic lattice, wherein the tufts are spaced about 9/16 inch on centers in rows that are spaced 3/16 inch on centers, wherein the fifth bristles extend about ¾ inch from the fifth brush head bed; and
wherein the sixth brush head has a sixth brush head bed, wherein the sixth brush head bed includes a sixth surface defining a sixth cylindrical segment, wherein the sixth brush head bed is distal to a brush head support face formed in the at least one first frame, wherein a plurality of sixth bristles extend from the sixth brush head bed, wherein the sixth bristles are cylindrical having a diameter of about 1/64 inch and a length of about 17/32 inch, wherein each sixth bristle is normal to the sixth surface defining the sixth cylindrical segment, wherein the sixth bristles are spaced about ¼ inch on centers in rows that are spaced about ⅛ inch on centers at the sixth surface defining the sixth cylindrical segment, wherein each sixth bristle has a ball end affixed to an end of the respective sixth bristle, wherein the ball end has a diameter of about 1/32 inch.

29. The kit as defined in claim 28, further comprising:
a second frame including a second crossmember, wherein the handle is selectably attachable to the second frame, wherein the connecting end of the handle is complementary with a second frame connector defined on the second frame;
at least one first brush head retention groove defined in the second frame, parallel to the handle rotational axis of symmetry, wherein the at least one first brush head retention groove is to engage and selectably retain the first of the at least two brush heads, wherein the second frame and the first of the at least two brush heads together define a second latching mechanism for selectably latching the first of the at least two brush heads in a second service position and for resisting a predetermined threshold disengaging force; and
at least one second brush head retention groove defined in the second frame, parallel to the handle rotational axis of symmetry, wherein the at least one second brush head retention groove is to engage and selectably retain a second of the at least two brush heads, wherein the second frame and the second of the at least two brush heads together define a third latching mechanism for selectably latching the second of the at least two brush heads in a third service position and for resisting the predetermined threshold disengaging force, wherein two of the at least two brush heads are simultaneously respectively mountable in the second service position and the third service position.

30. The kit as defined in claim 29 wherein the at least one first brush head retention groove includes a first pair of opposed, parallel peripheral grooves defined at a first edge of a first recessed brush head support face formed on the second frame, wherein the first pair of parallel peripheral grooves is defined parallel to the handle rotational axis of symmetry; wherein the first of the at least two brush heads includes first complementary flanges to engage the first pair of parallel peripheral grooves to facilitate mounting the first of the at least two brush heads on the second frame by sliding the first complementary flanges into the first pair of parallel peripheral grooves;
wherein the at least one second brush head retention groove includes a second pair of opposed, parallel peripheral grooves defined at a second edge of a second recessed brush head support face formed on the second frame, wherein the second pair of parallel peripheral grooves is defined parallel to the handle rotational axis of symmetry; wherein the second of the at least two brush heads includes second complementary flanges to engage the second pair of parallel peripheral grooves to facilitate mounting the second of the at least two brush heads on the second frame by sliding the second complementary flanges into the second pair of parallel peripheral grooves,
wherein the first of the at least two brush heads is mountable in the first pair of parallel peripheral grooves, and wherein the second of the at least two brush heads is mountable in the second pair of parallel peripheral grooves.

31. The kit as defined in claim 28, wherein the at least one first frame includes:
a parallel frame, wherein the handle rotational axis of symmetry is parallel to the roller axis of rotation of the parallel frame; and
an orthogonal frame, wherein the handle rotational axis of symmetry is orthogonal to the roller axis of rotation of the orthogonal frame.
